(19) United States
(12) Patent Application Publication
(10) Pub. No.: US 2018/0187129 A1
(43) Pub. Date: Jul. 5, 2018

(54) ACID DETERGENT

(71) Applicant: DeLaval Holding AB, Tumba (SE)

(72) Inventors: Camelia Traistaru, Kansas City, MO (US); Thomas C. Hemling, Kansas City, MO (US); James Chapman, Lee's Summit, MO (US)

(21) Appl. No.: 15/740,717

(22) PCT Filed: Jul. 6, 2016
(86) PCT No.: PCT/SE2016/050694

§ 371 Date: Dec. 28, 2017

Related U.S. Application Data
(60) Provisional application No. 62/189,605, filed on Jul. 7, 2015.

(51) Int. Cl. C11D 3/34; C11D 3/04; C11D 3/39; C11D 3/40; C11D 3/43; C11D 3/00; C11D 1/722; C11D 1/825; C11D 11/00

(52) U.S. Cl. CPC C11D 3/3409; C11D 3/042; C11D 3/3942; C11D 3/40; C11D 11/0041; C11D 3/0047; C11D 1/722; C11D 1/825; C11D 3/43

(57) ABSTRACT

Acid detergent compositions, concentrates and use solutions prepared from the concentrates and methods of using the same are provided. The acid detergent compositions are particularly suited for use in removing soils, especially milk soils, from clean-in-place systems, such as those commonly used in the dairy and food processing industries. The detergent compositions comprise an acidic component including an inorganic or alkanesulfonic acid and a blend of surfactants to provide high cleaning efficiency and low foam generation. The acid detergent compositions optionally comprise an antimicrobial agent to impart a sanitization functionality to the detergent.

### RELATED APPLICATION

The present application claims the benefit of U.S. Provisional Patent Application No. 62/189,605, filed Jul. 7, 2015, which is incorporated by reference herein in its entirety.

### BACKGROUND OF THE INVENTION

### Field of the Invention

The present invention is generally directed toward acid detergent compositions particularly suited for use in clean-in-place systems, such as those commonly used in the dairy and food processing industries, and methods of using such detergents to clean, and optionally sanitize, CIP equipment.

### Description of the Prior Art

Clean-in-place (CIP) systems are commonly used in many food industries, including dairy, beverage, brewing, and processed foodstuffs. These systems are also commonly used in the pharmaceutical and cosmetics industries. These systems are designed such that the interior pipes, vessels, process equipment, and associated fittings can be cleaned without disassembly of the equipment. Adequate cleaning of food preparation surfaces is a necessity to ensure the safety of the food supplied to consumers. This is especially true for the dairy industry, food preparation and processing plants, including food and beverage plants, and particularly in the area of milk handling and storing. Fresh milk must be immediately cooled and refrigerated after being obtained from the cow in order to prevent the milk from spoiling. Consequently, the piping systems, equipment, storage tanks, and utensil surfaces which handle the flow of milk must be cleaned after each milking in order to remove milk soils so as to prevent contamination of the fresh milk supply during subsequent milking operations. Most dairies operate using at least two milkings per day. This means that the CIP systems must be cleaned at least twice per day.

The cleaning process typically employees multiple steps including: pre-rinse, hot alkaline, or chlorinated alkaline cleaning, acid rinse for mineral deposit and scale removal, post rinse and sanitizing. If the number of cleaning process steps could be reduced, water and energy usage could also be reduced as would be the down time for cleaning thereby increasing the available production hours. Cleaning of milk and other food stuffs has traditionally employed the use of chlorinated alkaline detergents to provide most of the cleaning performance. Milk soils for example are composed of triglycerides and protein. Hot strong alkaline solutions hydrolyze the triglycerides and hypochlorite cleaves the protein molecules. Acid detergents typically have very limited effect on triglycerides but can solubilize some protein at low pH. There appears to be a need in the art for an acid detergent that is effective against triglyceride and protein soils, while maintaining its efficacy for mineral and scale removal.

Also, in some applications, it is desirable to avoid the use of chlorine (hypochlorite) as it can be corrosive to certain equipment surfaces, can reduce the lifetime of certain rubber materials, and is know to form traces of chloroform by reaction with organic materials. Chloroform has been shown to be a residue in milk and other food products, as a result of cleaning with chlorinated detergents.

U.S. Pat. No. 7,494,963 discloses certain acid detergent compositions effective at cleaning milk soil from clean-in-place (CIP) equipment. However, it has been discovered that under certain use conditions, these compositions produce an unacceptably high level of foam within the equipment. Too high of foam production makes it difficult to adequately rinse the detergent from the equipment following cleaning operations.

### SUMMARY OF THE INVENTION

The present invention is generally directed toward acid detergent compositions that include an acid mixture (e.g., phosphoric acid or an organic acid combined with methanesulfonic acid) to aid in mineral soil removal and a surfactant combination to impart cleaning efficiency and low-foam properties. In certain embodiments, one of the surfactants utilized may be very effective for cleaning, but has high-foam characteristics under use conditions. A second surfactant, however, acts as a defoamer providing a low-foam product. The detergent compositions can achieve excellent cleaning efficiency of milk soils of greater than 90% in laboratory tests. In certain embodiments, the detergent comprises a sanitizing component, which does not affect the cleaning capabilities of the detergent, but still exhibits >5 log reduction against certain bacteria, such as S. aureus and P. aeruginosa at 20° C., 5 minute contact and no soil in an EN1040 test, and a >5 log reduction against certain bacteria, such as E. coli, E. hirae, S. aureus and P. aeruginosa at 20° C., 5-minute contact and no soil in an EN1276 test. In certain embodiments, depending upon acid selection, the detergent compositions can be characterized as biodegradable and sustainable acid cleaners.

According to one embodiment of the present invention there is provided a concentrated detergent composition comprising an acidic component and first and second surfactants. The acidic component comprises an inorganic acid or alkanesulfonic acid alone or optionally in combination with an organic acid or another acid that is different than the first inorganic or alkanesulfonic acid. The first surfactant is a non-ionic surfactant, and the weight ratio of the first surfactant to the second surfactant in said composition is from about 2.2:1 to about 22:1. The weight ratio of the acidic component to the sum of the first and second surfactants is from about 2:1 to about 40:1. The acid component and the first and second surfactants collectively comprise from about 20% to about 100%, or from about 25% to about 75% by weight of the composition.

According to another embodiment of the present invention there is provided a detergent use solution comprising from about 0.05% to about 5% v/v of a concentrated detergent composition prepared as described herein diluted with water.

According to yet another embodiment of the present invention there is provided a method of removing food soils from a surface of clean-in-place equipment comprising the step of contacting said surface of the clean-in-place equipment with a liquid detergent comprising an acidic component and first and second surfactants. The acidic component comprises an inorganic acid or alkanesulfonic acid alone or optionally in combination with an organic acid or another acid that is different than the first inorganic or alkanesulfonic acid. The first surfactant is a non-ionic surfactant, and the weight ratio of the first surfactant to the second surfactant in said composition is from about 2.2:1 to about 5.75:1. The weight ratio of the acidic component to the sum of the first and second surfactants is from about 2:1 to about 11:1.

According to another embodiment of the present invention, dairy and food processing equipment can be cleaned with the acid detergents described herein without the use of an alkaline cleaning step.

According to still another embodiment of the invention, the acid detergents described herein can be used with a substantially abbreviated pre-rinse or no pre-rinse step.

According to a further embodiment of the present invention, the acid detergents described herein can be used to clean and sanitize CIP equipment in a single step.

### DETAILED DESCRIPTION OF THE PREFERRED EMBODIMENT

The present invention generally is directed toward detergent compositions, concentrates and ready-to-use or “use solution” formulations, comprising an acidic component and a surfactant blend that is results in reduced foam generation under certain use conditions, especially in clean-in-place (CIP) equipment. In certain embodiments, the detergent compositions include an acid mixture to aid in mineral soil removal and a surfactant combination that imparts cleaning efficiency and low-foaming characteristics. In certain embodiments, the detergent compositions comprise an optional sanitizing component so as to provide cleaning, descaling, and sanitization of CIP equipment in a single step.

As used herein the term “CIP equipment” generally refers to systems configured to handle and/or process a flowable substance, such as liquids, emulsions, and possibly solid particulate materials, that do not require complete disassembly in order to clean the interior surfaces, namely those surfaces coming into contact with the material being flowed therein and/or therethrough. CIP equipment may comprise, for example, tanks, other types of vessels, filters, pumps, pipes, hoses, and associated fittings. CIP equipment is distinguishable from single-dimension surfaces such as plates, test coupons, countertops, walls, and the like in that CIP equipment generally defines an internal space in which the detergent composition may be contained within and/or circulated within the equipment. Therefore, the CIP equipment surfaces to be cleaned with the detergent composition are generally interior surfaces of the equipment that come into contact with flowable substances being handled thereby.

CIP equipment is often used in food handling and processing applications, including those involving dairy products. In one particular application, CIP equipment is used in milk handling and processing. At the conclusion of the processing of a volume of milk, milk residues remain within the equipment, and particularly on the interior surfaces of the equipment. In order to prevent contamination of the fresh milk supply during subsequent milk-handling operations, the CIP equipment must be cleaned. Proteins and minerals from the milk may also become deposited on the interior surfaces of the CIP equipment resulting in the formation of scale. It is desirable to eliminate and/or prevent the formation of scale on these surfaces.

In yet another particular application, the CIP equipment is used in the brewery industry. Given the acid nature of the inventive detergents, cleaning can be performed under CO₂ pressure, typically between about 10 to about 40 psi for secondary fermentation equipment (bright beer or conditioning tanks) thus eliminating the need for purging the tanks prior to the cleaning process saving time and cost.

In one embodiment, the present invention provides a detergent composition that is well suited for use in cleaning CIP equipment, including equipment containing milk soils, fruit and vegetable soils, proteinaceous soils, brewery equipment, etc. In a particular embodiment, the detergent composition is in the form of a concentrate that may be diluted to form a use solution, which is circulated within the CIP equipment during cleaning operations.

The detergent concentrate generally comprises an acidic component containing an inorganic acid or alkanesulfonic acid alone or optionally in combination with an organic acid or another acid that is different than the first inorganic or alkanesulfonic acid. In certain embodiments, the inorganic acid comprises a mineral acid. Exemplary inorganic acids include nitric, sulfuric and phosphoric acids. In certain embodiments, the alkanesulfonic acid comprises a lower alkyl (C1-C16) carbon chain sulfonic acid. Exemplary lower alkylsulfonic acids include methanesulfonic acid (MSA), ethanesulfonic acid, propanesulfonic acid, and butanesulfonic acid, with MSA being particularly preferred. In certain embodiments, the inorganic or alkanesulfonic acid is generally present within the detergent concentrate at a level of from about 1% to about 98%, from about 2% to about 30%, or from about 3% to about 20% by weight, based upon the entire weight of the concentrate.

The optional secondary acid comprising the acidic component can comprise, consist of, or consist essentially of an organic acid, inorganic acid, or mixture thereof. Exemplary organic acids include formic acid, acetic acid, hydroxyacetic acid, propionic acid, hydroxypropionic acid, a-ketopropionic acid, butyric acid, mandelic acid, valeric acid, tartaric acid, malic acid, oxalic acid, fumaric acid, citric acid, maleic acid, sorbic acid, benzoic acid, succinic acid, glutaric acid, adipic acid, and α-hydroxy acids such as glycolic acid and lactic acid. In certain embodiments, lactic, citric, acetic, and glycolic acids are particularly preferred. Exemplary inorganic acids include nitric, sulfuric and phosphoric acids, with phosphoric acid being particularly preferred. It is understood that the term “secondary acid” does not necessarily mean that the acid is present in a minority amount, although in certain embodiments the alkanesulfonic acid is present in a greater amount than the secondary acid. Thus, it is within the scope of the present invention for the secondary acid to be present in an amount greater than the alkane sulfonic acid. In certain embodiments, the secondary acid component is generally present within the detergent concentrate at a level of from about 1% to about 25%, from about 2.5% to about 20%, or from about 4% to about 15% by weight, based upon the entire weight of the concentrate.

The surfactant blend comprises at least two surfactants, at least one of which is a non-ionic surfactant. Preferred nonionic surfactants include capped or uncapped poly-lower alkoxylated higher alcohols or ether derivatives thereof, in which the alcohol or ether contains 6 to 20 carbon atoms and the number of moles of lower alkylene oxide (2 or 3 carbon atoms) is from 3 to 12. Exemplary alkyl alkoxylated alcohols or ethers suitable for use with the present invention include the water soluble or dispersible nonionic surfactants from BASF under the name PLURAFAC (Fatty alcohol alkoxylates), and LUTENOL (fatty alcohol ethoxylates). These surfactants generally comprise the reaction product of a higher linear alcohol and a mixture of propylene and ethylene oxides. Specific examples include a (C13-C15) fatty alcohol condensed with 6 moles of ethylene oxide and 3 moles of propylene oxide and a (C13-C15) fatty alcohol condensed with 7 moles of propylene oxide and 4 moles of ethylene oxide. Preferred PLURAFAC surfactants include Plurafac® LF220 (hydroxyl terminated), Plurafac® LF-303 (polyglycol ether), Plurafac® LF-305 (C8-C14 alkyl chain), Plurafac® S-305LF, Plurafac® SLF-18B (C6-C10 ethoxylated linear alcohol), Plurafac® SLF-18B45, Plurafac® LF-4030. Other exemplary nonionic surfactants include those by Shell Chemical Company under the name NEODOL. These surfactants are condensation products of a mixture of higher fatty alcohols averaging about 12 to 15 carbon atoms with about 6-7 moles of ethylene oxide. Yet additional exemplary nonionic surfactants include those from Union Carbide under the names TERGITOL and TRITON, and the low foaming, biodegradable alkoxylated linear fatty alcohols by BASF under the name POLY-TERGENT. Still another exemplary nonionic surfactant that may be used with the present invention is Degressal® SD 20, a fatty alcohol alkoxylate from BASF.

The detergent concentrates may include other anionic, cationic, amphoteric, and zwitterionic surfactants, or mixtures thereof, which are stable in highly acidic conditions and in the presence of oxidants such as oxygen bleach and especially peroxide and peroxy acid bleach. Exemplary water-soluble organic anionic surfactants include amine oxide, phosphine oxide, sulphoxide, sulfonate, sulfate, and betaine surfactants. One especially preferred class of anionic surfactants include the linear or branched alkali metal mono- and/or di-(C8-C14) alkyl diphenyl oxide mono- and/or disulfonates, available from Dow Chemical Company under the name DOWFAX. Other preferred anionic surfactants include the primary alkyl sulfates, alkyl sulfonates, arylalkylsulfonates and secondary alkylsulfonates. Exemplary anionic surfactants include sodium (C10-C18) alkylsulfonates such as sodium dodecylsulfonate, sodium alkylsulfonates such as sodium hexdecyl-1-sulfonate, and sodium (C12-C18) alkylbenzenesulfonates such as sodium dodecylbenzenesulfonate. The corresponding potassium salts of the foregoing can also be used.

Other exemplary surfactants that may be used in the present invention are the alkylpolysaccharide surfactants having a hydrophobic group containing from about 8-20 carbon atoms. Preferably, these surfactants comprise from about 10 to 16 carbon atoms (about 12-14 most preferably) in the hydrophobic group and from about 1.5-10 saccharide units (i.e, fructosyl, glucosyl and galactosyl units and mixtures thereof). Preferred alkylpolysaccharide surfactants for use with the present invention include alkylpolyglucoside surfactants by BASF under the name APG. These APG surfactants are characterized by the general formula (CₙH₂ₙ₊₁)O(C₆H₁₀O₅)ₓH.

Cationic surfactants for use with the present invention include those comprising amino or quaternary ammonium hydrophilic moieties that are positively charged when dissolved in the inventive detergents. Preferred quaternary ammonium surfactants are quaternary ammonium salts including dialkyldimethylammonium chlorides and trialkylmethylammonium chlorides, wherein the alkyl groups comprise from about 10-22 carbon atoms and are derived from long chain fatty acids, such as hydrogenated tallow fatty acids, coconut fatty acids, oleo fatty acids, soya fatty acids. Exemplary quaternary ammonium salts include ditallowdimethylammonium chloride and ditallowmethylammonium chloride. Salts of primary, secondary, and tertiary fatty amines may also be used as the cationic surfactant in the inventive detergents. Preferably, the alkyl groups of such amines comprise from about 10-22 carbon atoms and may be substituted or unsubstituted. Secondary and tertiary amines are particularly preferred, with tertiary amines being most preferred. Exemplary amines include stearamidopropyldimethyl amine, diethylaminoethyl stearamide, dimethyl stearamine, myristyl amine, and ethoxylated stearylamine. Preferably, the amine salts are selected from the group consisting of halogen, acetate, phosphate, nitrate, citrate, lactate and alkyl sulfate amine salts.

Amphoteric surfactants for use with the present invention include those broadly described as derivatives of aliphatic secondary and tertiary amines in which the aliphatic radical is straight or branched chain and wherein one of the aliphatic radicals comprises from about 6-18 carbon atoms and another of the aliphatic radicals includes an anionic hydrophilic group such as a carboxylate, sulfonate, sulfate, phosphate, or phosphonate. Exemplary amphoteric surfactants include sodium 3-decylaminopropionate, sodium 3-decylaminopropane sulfonate, sodium lauryl sarcosinate, and N-alkyltaurines such as those derived from dodecylamine and sodium isethionate.

Zwitterionic surfactants for use with the present invention include those derived from aliphatic quaternary ammonium, phosphonium, and sulfonium compounds, in which the aliphatic radicals are straight or branched chain, and wherein at least one of the aliphatic groups contains from about 8-18 carbon atoms and one anionic group selected from carboxylate, sulfonate, sulfate, phosphate, or phosphonate.

The requisite non-ionic surfactant is generally present in an amount greater than the others, and is often referred to herein as “the first surfactant.” This surfactant generally imparts a high degree of cleaning efficiency to the detergent composition. The at least one other surfactant that is different from the requisite non-ionic surfactant, often referred to herein as “the second surfactant,” is generally present in an amount that is less than the first surfactant. In certain embodiments the second surfactant may also comprise a non-ionic surfactant, although this need not always be the case. Also, the second surfactant generally exhibits foam-reducing or foam-suppressing characteristics. In one embodiment, the first surfactant comprises Plurafac® LF220, a branched and linear butoxylated and ethoxylated C13-C15 alcohol, and the second surfactant comprises Degressal® SD 20, a propoxylated C9-C11 alcohol.

In certain embodiments, the first surfactant is present in the detergent concentrate at a level of from about 0.5% to about 11%, from about 1% to about 8%, or from about 2.5% to about 6% by weight, based upon the entire weight of the detergent concentrate. In certain embodiments, the second surfactants present in the detergent concentrate at a level of from about 0.1% to about 5%, from about 0.25% to about 3%, or from about 0.5% to about 1.5% by weight, based upon the entire weight of the detergent concentrate. The detergent concentrates (and their corresponding use solutions) exhibit a weight ratio of the first surfactant to the second surfactant of from about 2.2:1 to about 22:1, from about 5:1 to about 18:1, or from about 7:1 to about 14:1.

In certain embodiments, the detergent concentrates (and their corresponding use solutions) exhibit a weight ratio of the acidic component to the sum of the at least first and second surfactants of the surfactant blend of from about 2:1 to about 40:1, from about 3:1 to about 35:1, or from about 4:1 to about 30:1. In certain embodiments, the acid component and the first and second surfactants collectively comprise from about 20% to about 100%, from about 25% to about 80%, or from about 30% to about 60% by weight of the detergent concentrate.

In certain embodiments, the detergent concentrates exhibit a pH of less than 2, of less than 1, or from about −1 to about 1, or from about −0.7 to about 0.4.

In certain embodiments, the detergent concentrates are non-chlorinated (i.e., are substantially free of chlorine, chlorite, hypochlorite, and chloride ions). In certain embodiments, the detergent concentrates do not comprise any diaminopropane compounds.

In the food processing industry it is important to sanitize food-handling equipment so as to avoid build up of potentially harmful microbial species such as gram-positive and gram-negative bacteria (e.g., Pseudomonas aeruginosa, Escherichia coli, Staphylococcus aureus, Enterococcus hirae, Salmonella enterica and Listeria monocytogenes) that could contaminate the food product. Therefore, detergent concentrates according to the present invention can be formulated with sanitizing functionality. Such embodiments generally further comprise an antimicrobial agent.

Antimicrobial organic acids are antimicrobial agents that can be used with the present invention. Exemplary antimicrobial organic acids include dodecylbenzenesulfonic acid, napthalenesulfonic acid, benzoic acid, and short chain fatty acids (such as octanoic acid, decanoic acid, nonanoic acid), sulfonated oleic acid, salicylic acid, and α-hydroxy acids (such as lactic acid and glycolic acid). The term “short chain fatty acids” as used herein refers to those acids generally having from about 4-15 carbon atoms, preferably from about 6-12 carbon atoms, and more preferably from about 8-10 carbon atoms. In various preferred embodiments, a blend of a C8-C9 fatty acid and a C10-C12 fatty acid is used. Additional exemplary short chain fatty acids include octanoic acid (caprylic acid, C8 alkyl radical), decanoic acid (capric acid, C10 alkyl radical), and blends thereof.

Antimicrobial agents like chlorophenols, (e.g., p-choro-m-xylenol (PCMX) and 2,4,4-Trichloro-2-hydoxydiphenyl ether (Trichlosan)), chlorohexidine, and iodine can be used with the present invention. Additional antimicrobial agents include nontoxic biodegradable monohydric alcohols, selected polyhydric alcohols, aromatic and aliphatic alcohols. Exemplary monohydric alcohols are selected from the group consisting of isopropyl, methyl, ethyl, propyl, isopropyl, n-butyl, isobutyl, tert-butyl, benzyl, and allyl alcohols and mixtures thereof. Exemplary polyhydric alcohols are selected from the group consisting of propylene glycol, 1,3-propanediol, 1,2-butanediol, polyethylene glycol 400, glycerol, and 1,4-butanediol and mixtures thereof.

Non-chlorine bleaches, such as oxygen bleaching agents, can be used as antimicrobial agents. Exemplary oxygen bleaching agents include organic and inorganic peroxygen bleaches and peracids, such as hydrogen peroxide, and activated hydrogen peroxides like peracetic acid. The term “peroxygen compound” as used herein refers to any compound having a chemical formula including a —O—O— structure. Preferred peroxyacids for use with the present invention have the general structure: R—COOOH wherein R is a C1-C18 substituted or unsubstituted, saturated or unsaturated, linear, branched, or cyclic aliphatic, alkyl, or aromatic moiety. R substituent groups can include —OH, —COOH, or heteroatom (—O—, —S—, etc.) moieties, so long as the antimicrobial properties of the compositions are not significantly affected. Exemplary peroxyacid compounds are selected from the group consisting of peroxyfatty acids, monoperoxy or diperoxydicarboxylic acids, peroxyaromatic acids, peracetic acid, peroxypyruvic acid and perbenzoic acid. In a particular embodiment in which the acidic component comprises a lower carboxylic acid, such as acetic acid, hydrogen peroxide is also added to the detergent. The hydrogen peroxide then reacts in situ with the carboxylic acid to produce the peroxy acid compound, such as peracetic acid.

Bronopol (2-bromo-2-nitro-1,3-propanediol) is a water soluble broad spectrum antimicrobial preservative that is especially effective against Pseudomonas aeruginosa. Bronopol is a formaldehyde-releasing agent that decomposes to formaldehyde and bromine compounds in neutral and alkaline pH conditions.

Other antimicrobial compounds include several biguanide products, especially poly(hexamethylene biguanide) hydrochloride (PHMB), chlorohexidine diacetate (CHA) and chlorohexidine digluconate (CHG). These compounds are highly effective broad spectrum bactericides and are available from Avecia under the name VENTOCIL. Other biguanide formulations for use as antibacterial agents in accordance with the present invention include cationic formulations comprising about 20% by weight PHMB and formulations comprising about 20% by weight CHG.

When present, the antimicrobial agent may be used in the concentrated detergent composition at a level of from about 0% to about 30%, from about 2% to about 20%, or from about 5% to about 15% by weight based on the total weight of the concentrate.

Metal ion chelating agents can be added to the detergent concentrates to enhance germicidal activity and cleaning performance. Exemplary chelating agents include 1-hydroxyethane 1,1-diphosphonic acid (HEDP), ethylenediaminetetraacetic acid (EDTA), sodium ethylenediamineteraacetate salt (Na₄-EDTA), phosphonic acid, octyl phosphonic acid, acrylic acid, polyacrylic acid, aspartic acid, salicylic acid, succinic acid, tartaric acid, ascorbic acid, benzoic acid, sodium benzoate, p-hydroxy benzoic acids and the corresponding esters derivatives (parabans). In certain embodiments, the metal ion chelating agent is present within the concentrated detergent composition at a level of from about 0% to about 5%, from about 0.25% to about 3.5%, or from about 0.5% to about 2% by weight based on the weight of the total composition.

The balance of the detergent concentrate (i.e., to give 100% by weight) is water, preferably softened or deionized water. Organic solvents, such as alcohols and glycols, preferably propylene glycol and glycerin, and combinations thereof can be used in place of the water if a non-aqueous detergent concentrate is desired, or along with water in aqueous systems. In aqueous systems, organic solvents may be added at a level of from about 0% to about 15%, about 1% to about 10%, or about 2% to about 8% by weight based on the weight of the total concentrate. Other ingredients such as perfume/fragrance, preservatives, colorants, solvents, buffers, stabilizers, radical scavengers, soil suspenders, crystals growth inhibiting agents, soil release agents, dispersants, dyestuffs, and pigments can be included provided they are stable in a highly acidic environment.

The detergent concentrates described above are capable of being diluted with water to form a ready-to-use cleaning composition, a “use solution”. In certain embodiments, the concentrate is diluted with water at a weight ratio of between about 1:10 to 1:300, and more preferably between about 1:100 to 1:250. In alternate embodiments, the use solutions may comprise from about 0.01% to about 10%, from about 0.25% to about 7.5%, or from 0.05% to about 5% volume of concentrate per total volume of solution. An exemplary use solution expressed in terms of volume of concentrate per total volume of solution is about 0.3-1.0 oz/gal. In certain embodiments, the pH of the use solution is from about 0.1 to about 5, from about 1 to about 4, or from about 2.1 to about 2.5.

Table 1 summarizes exemplary detergent concentrates prepared in accordance with the present invention. Tables 2 and 3 summarize exemplary use solutions prepared using the detergent concentrates according to the present invention. It is understood that the detergent concentrates, and the use solutions prepared therefrom, may comprise, consist of, or consist essentially of the components identified in the tables below.

Table 1 summarizes exemplary detergent concentrates prepared in accordance with the present invention.

| | Broad | Intermediate | Narrow |
|---|---|---|---|
| | range | range | range |
| Ingredient | (wt. %) | (wt. %) | (wt. %) |
| Alkanesulfonic acid | 1-94.4% | 2-80% | 3-50% |
| Other acid, organic or | 1-98% | 2.5-50% | 4-30% |
| inorganic | | | |
| Primary non-ionic | 0.5-14% | 1-10% | 2.5-8% |
| surfactant | | | |
| Secondary surfactant | 0.1-5% | 0.25-3% | 0.5-1.5% |
| Optional chelating | 0-5% | 0.25-3.5% | 0.5-2% |
| agent | | | |
| Optional antimicrobial | 0-50% | 5-45% | 15-40% |
| agent(s) | | | |
| Optional organic | 1-15% | 1-10% | 2-8% |
| solvent | | | |
| Water | 0-80% | 5-70% | 10-60% |

Table 2 summarizes exemplary detergent use solutions prepared in accordance with the present invention.

| | Broad | Intermediate | Narrow |
|---|---|---|---|
| | range | range | range |
| Ingredient | (wt. %) | (wt. %) | (wt. %) |
| Alkanesulfonic acid | 0.0005-4.7% | 0.001-4.0% | 0.0015-2.5% |
| Other acid, organic or | 0.0005-4.9% | 0.0013-2.5% | 0.002-1.5% |
| inorganic | | | |
| Primary non-ionic | 0.0003-0.7% | 0.0005-0.5% | 0.0013-0.4% |
| surfactant | | | |
| Secondary surfactant | 0.00005-0.25% | 0.00013-0.15% | 0.0003-0.075% |
| Optional chelating | 0-0.25% | 0.00013-0.175% | 0.0003-0.1% |
| agent | | | |
| Optional antimicrobial | 0-2.5% | 0.003-2.25% | 0.008-2.0% |
| agent(s) | | | |
| Optional organic | 0.0005-0.75% | 0.0005-0.5% | 0.001-0.4% |
| solvent | | | |
| Water | Q.S. | Q.S | Q.S. |

Table 3 summarizes alternate exemplary detergent use solutions prepared in accordance with the present invention.

| | Broad | Intermediate | Narrow |
|---|---|---|---|
| | range | range | range |
| Ingredient | (wt. %) | (wt. %) | (wt. %) |
| Alkanesulfonic acid | 0.002-1.9% | 0.004-1.6% | 0.006-1% |
| Other acid, organic or | 0.002-2.0% | 0.005-1% | 0.008-0.6% |
| inorganic | | | |
| Primary non-ionic | 0.001-0.28% | 0.002-0.2% | 0.005-0.16% |
| surfactant | | | |
| Secondary surfactant | 0.0002-0.1% | 0.0005-0.06% | 0.001-0.03% |
| Optional chelating | 0-0.1% | 0.0005-0.07% | 0.001-0.04% |
| agent | | | |
| Optional antimicrobial | 0-1% | 0.01-0.9% | 0.03-0.8% |
| agent(s) | | | |
| Optional organic | 0.002-0.3% | 0.002-0.2% | 0.004-0.16% |
| solvent | | | |
| Water | Q.S. | Q.S | Q.S. |

Detergent concentrates and use solutions made by diluting those concentrates can be used in methods of cleaning CIP equipment. In certain embodiments, the cleaning processes of CIP equipment involve a pre-rinse step in which water at about 37-49° C. (100-120° F.) is flowed or otherwise circulated through the equipment, contacting substantially all soiled surfaces. The goal in this step is to soften or melt the fats, without using water so hot as to denature the proteins and create scale. In the second step, the system is washed with a cleaning solution made from a diluted concentrate and hot water at a temperature of from about 25° C. to about 85° C., from about 35° C. to about 80° C., or from about 40° C. to about 75° C., for a specified time period of from about 2 to about 20 minutes. Preferably, the interior surfaces coming into contact with the food or beverage products being processed with the CIP equipment are contacted with the cleaning solution by circulating the cleaning solution through the equipment for the specified period of time. In certain embodiments, the cleaning process may include a post-rinse step in which ambient temperature water is used to flush the system so as to remove residues of the cleaning solution from the CIP equipment.

In alternate embodiments, the pre-rinse step may be eliminated, thereby saving significant quantities of water and cleaning time. However, in other embodiments, particularly those embodiments pertaining specifically to beverage handling equipment, and even more specifically to milk handling equipment, it is within the scope of the present invention to include a low-volume pre-rinse step in order to remove or flush standing beverage or milk that could not otherwise simply be drained from the equipment. As explained below, this pre-rinse step is not intended to remove excess food or beverage that is clinging to the surfaces, rather due to the design of certain CIP systems, significant quantities of free-standing beverage may remain in the system and/or system lines. Thus, in order to prevent a loss of detergent efficacy, these free-standing quantities of food or beverage need to be removed via a low water volume pre-rinse. Alternatively, the free-standing quantities of beverage may be diluted by circulating the cleaning solutions in two portions. The first portion of cleaning solution containing only water effectively dilutes the soil that would otherwise accumulate in the first slug of cleaning solution that circulates in the system.

The embodiments of the present invention described herein are particularly suited for use with CIP equipment such as that found on dairy farms and in a number of food and beverage processing and handling facilities. One exemplary type of CIP equipment comprises a batch tank in which cleaning and/or rinse solutions may be held during the cleaning cycle. The batch tank provides a container for mixing the detergent concentrate into the water to be circulated through the various portions of the CIP equipment during the cleaning process. After completing a circuit through the equipment, the solutions are typically returned to the tank to await further circulation. Another type of CIP equipment foregoes the batch tank and instead utilizes apparatus for adding detergent concentrate in-line as the cleaning solution circulates through the processing equipment. The cleaning and rinsing solutions may circulate through the CIP equipment as substantially continuous streams, or as discrete slugs of solution separated by pockets of air.

In one embodiment, the cleaning step is performed without having first performed any kind of pre-rinse step. As commonly understood, a “pre-rinse” step is a procedure by which typically fresh water is circulated through the handling or processing equipment in order to remove or loosen various soils so as to conserve detergent or improve the cleaning efficacy of the cleaning step. Typically, the volume of water used in the pre-rinse step is roughly the same as the volume of cleaning solution and post-rinse solution that are circulated through the system during the cleaning and rinsing steps, respectively. However, generally, the volume of water used in the pre-rinse step is at least 75% of the volume of cleaning solution that is used during the cleaning step.

In another embodiment of the present invention, a volume of cleaning solution is circulated through the handling or processing equipment in a plurality of passes to effect a reduction of the soils on the equipment surfaces. However, after the first pass of the cleaning solution, a first portion of the cleaning solution is purged from the equipment. In certain embodiments this first portion constitutes the “first runnings” or the first slug of cleaning solution to pass through the equipment. As discussed above, certain CIP equipment contains significant quantities of food or beverage that, due to the system design, cannot be automatically drained from the system. This first portion of cleaning solution contacts the free-standing food or beverage remaining in the system prior to the cleaning step and “drives” it out of the system. Accordingly, this first portion of cleaning solution is purged so as to not reduce the efficacy of the remaining detergent within the system. The remaining cleaning solution continues to be passed through the equipment for the remainder of the cleaning step. In certain embodiments, the first portion of cleaning solution that is purged from the equipment comprises less than 25% by volume of the total volume of cleaning solution circulated during the first pass. In other embodiments, the purged portion comprises less than 15%, or less than 5% of the total volume of cleaning solution circulated during the first pass. By purging the first slug of cleaning solution after the first pass, the need for a conventional pre-rinse step is eliminated thereby conserving considerable amounts of fresh water.

In another embodiment, the cleaning step comprises introducing a first portion of a cleaning fluid, preferably fresh water, into the equipment thereby contacting the surfaces thereof. Subsequently, a second portion of cleaning fluid is introduced into the equipment thereby contacting the surfaces thereof. The second portion of cleaning fluid comprises an acidic detergent composition according to the present invention. The first and second portions of cleaning fluid are circulated simultaneously through the equipment for the duration of the cleaning step. Note, in this embodiment, the first portion of cleaning fluid is not purged from the system. In this embodiment, the first portion of cleaning fluid picks up and dilutes the free-standing quantities of food or beverage remaining in the system so as not to reduce the effectiveness of the detergent that is contained within the second portion of cleaning fluid. Again, the need for a pre-rinse step is eliminated thereby conserving water. In certain embodiments, the first portion of cleaning fluid comprises less than 25% by volume of the total cleaning fluid used in the cleaning step. In other embodiments, the first portion of cleaning fluid comprises less than 15%, or less than 5% by volume of the total cleaning fluid used in the cleaning step.

In yet another embodiment of the present invention, a pre-rinse step is performed prior to the cleaning step. However, the volume of pre-rinse fluid used is less than 50% of the volume of cleaning solution used in the cleaning step. In other embodiments, the volume of pre-rinse fluid used is less than 40%, preferably less than 25%, and most preferably less than 10% of the volume of cleaning solution used in the cleaning step. It is the primary function of the pre-rinse step to reduce the amount of “free-standing” food or beverage that cannot otherwise be drained from the system prior to the cleaning step. Therefore, it is not a target goal of the pre-rinse step to loosen or remove soils that are adhered to the surfaces of the equipment. Rather, the pre-rinse is primarily intended to reduce the amount of food or beverage to an acceptable level that does unacceptably interfere with or prevent the detergent used in the cleaning step from effecting the necessary system cleaning. Thus, the pre-rinse step may employ lower temperatures than conventional pre-rinse operations, thereby resulting in additional energy savings. For example, the pre-rinse solution or fluid may have a temperature of less than 40° C., less than 35° C., less than 30° C., between about 10° C. to about 35° C., or between about 15° C. to about 30° C.

It has been discovered that in order to obtain effective cleaning from the cleaning step, the food or beverage handling and processing equipment should contain less than 12% by volume of residual food or beverage, based upon the volume of cleaning solution to be circulated through the equipment, prior to the cleaning step, or at least prior to the introduction of detergent into the equipment during the cleaning step. In certain embodiments, the level of such food or beverage soils should be less than 10% by volume, or even less than 5% by volume, based upon the volume of cleaning solution to be circulated through the equipment.

After the specified time period, the surface is rinsed. In the rinsing step, the surface is contacted with a rinse solution for a sufficient time to remove any cleaning solution residue. Preferably, the rinse solution comprises fresh water (i.e., water that has yet to be cycled through the equipment). Preferably, the surface is rinsed for a specified period of from about 2 to about 20 minutes, and more preferably from about 4 to about 16 minutes, at a temperature of from about 5° C. to about 40° C., preferably from about 10° C. to about 35° C., and more preferably from about 15° C. to about 30° C. After the rinsing step, the surface is clean and descaled. Thus, in a single cleaning cycle the methods according to the present invention provide for the removal of at least about 90% of the food and/or beverage soil on the equipment surface, preferably from about 90%-99.9% of the soil is removed, and more preferably from about 95-98%, based upon the initial amount of food and/or beverage soil on the equipment surface prior to the cleaning cycle.

The inventive method also preferably sanitizes the surface at cleaning temperatures of at least about 40° C., resulting in at least a 4-log reduction, and more preferably at least a 5-log reduction, and most preferably at least a 6-log reduction in the amount of bacteria or microorganisms on the target surface after a single cleaning cycle. As used herein, the term “cleaning cycle” refers to a single cleaning step, followed by a post-rinse step, and in certain embodiments, without a pre-rinse step. Thus, in certain embodiments, in a single cleaning cycle, a soiled surface is not pre-rinsed, but is first contacted with the cleaning solution for a specified period of time, and is then rinsed with the rinsing solution to directly thereafter yield a surface that is cleaned, sanitized, and descaled.

In one embodiment, the cleaning solution is run through the equipment for a single cleaning cycle and then drained from the equipment and discarded. That is, once the cleaning solution is drained after the single cleaning cycle, it is not reintroduced into the equipment during a subsequent cleaning cycle. Thus, in this embodiment, the cleaning solution is a single-use solution.

In another embodiment according to the invention, the rinse water is recovered after the rinsing step and reused during a subsequent cleaning cycle. Preferably, the rinse water is diverted to a holding tank after the rinsing step and is used in the cleaning solution of a subsequent cleaning cycle. According to this embodiment, a quantity of the detergent composition is introduced into the recovered rinse solution to produce a cleaning solution for the subsequent cleaning cycle having the desired detergent concentration, as described herein.

Detergent foaming is a concern especially for systems in which quick cleaning and rinsing cycles are important, such as CIP equipment that have wash cycles of about 6-8 minutes. A detergent's foaming characteristics can be determined in a dynamic environment by placing 300 mL of a use solution of the detergent, prepared using 300 ppm hard water, in a 1000 mL graduated cylinder. A gas, usually air, is then introduced into the detergent use solution at a flow rate of 2.0 L/min for approximately 15 seconds. The initial net volume of foam (total volume minus volume of liquid) is recorded. Measurements of the foam volume can also be made periodically until complete foam collapse is achieved. In certain embodiments, the dynamic foam test can be performed under any combination of the following test conditions: temperatures of 25° C., 45° C., and 65° C., and at use solution concentrations of 0.4% v/v, 0.5% v/v, 1.0% v/v, or 1.5% v/v of the detergent concentrate. The initial foam volume, upon stoppage of the gas flow, is less than 600 mL, less than 450 mL, or less than 150 mL. In certain embodiments, the time to total foam collapse, from stoppage of the gas flow, is less than 5 minutes, less than 4 minutes, less than 3 minutes, less than 2 minutes, less than 1 minute, or less than 30 seconds.

### EXAMPLES

The following examples describe various detergent compositions according to the present invention. It is to be understood, however, that these examples are provided by way of illustration and nothing therein should be taken as a limitation upon the overall scope of the invention.

### Cleaning Procedures

Many of the following examples involve cleaning evaluations of acid detergents according to the present invention. The cleaning efficacies of the samples were compared to those of commercially available acid detergents. In these cleaning tests, 304 stainless steel panels measuring 3″×6″×0.0037″, having a hole at one end were at first washed with a powder chloro-alkaline detergent, rinsed with water and wiped with xylene, then with isopropanol, followed by drying in an oven (100-110° C., for 10-15 minutes) to insure complete evaporation of the solvents. The panels were suspended in the oven by attaching a rigid wire hanger to the panel hole, so that no contact was made with the oven or other items within the oven. The dried panels were removed from the oven, and allowed to cool for at least 20 minutes. The panels were carefully handled so as to eliminate contact with soil sources, and the initial weight of each panel was recorded to the nearest 0.1 mg.

Evaporated milk was emptied into to a 1 L beaker along with de-ionized water (3:1, milk:water), and the mixture was stirred to insure homogeneity. Up to six panels were placed in the milk by setting the end without the hole on the bottom of the beaker and propping the other end of the panel against the side of the beaker. Approximately three quarters of the panel was immersed in the milk. The panels were allowed to sit in the milk for 10 minutes, removed and suspended by the wire hanger, and allowed to drain in air for 5 minutes. Each panel side was then rinsed with 50 ml of 300 ppm of synthetic hard water at room temperature. Synthetic hard water was prepared according to AOAC 5.025. Care was taken to pour the rinse water over each side of the panel so as to contact all of the soiled areas of the panel. The rinse water was allowed to drain off each panel and the panels were hung in a 40° C. oven to dry for 15 minutes. The panels were removed from the oven and allowed to cool for at least 15 minutes after each cycle (45 minutes on the last cycle). After cooling, the panels were weighed and each weight was recorded to the nearest 0.1 mg. The soil deposition, rinsing, drying and weighing cycle was carried out a total of five times for each panel, or until the soil weight fell within the range of 15-35 mg. The panels were allowed to stand at room temperature for a period of at least 8 hours to encourage soil adhesion to the panel prior to use.

The soiled panels were washed in a 1 L beaker using the inventive detergents and the control products. Approximately 1000 ml of synthetic hard water (17.6 grains/gal, 300 ppm of water hardness made by AOAC method) was placed in the beaker along with a specified amount of the detergent. All experimental detergents and all liquid controls were typically used at 0.4 wt % (i.e., 4 g/L concentration). The cleaning solution was heated using a hot plate to a temperature of 60° C., unless otherwise specified. In some wash cycles, a stress wash condition was used by lowering the detergent concentration, the wash temperature to below 60° C. and/or reducing the washing time to less than 8 minutes.

Each test panel was first immersed in the detergent solution for a period of 8 minutes with agitation via a magnetic stir bar. After the wash, each panel was removed from the wash bath and immediately rinsed in tap water for about 5 seconds. The panel was then suspended within the 40° C. oven for a period of about 15 minutes to dry. The panel was removed from the oven, cooled in the air for about 30 minutes and then reweighed. The weight of the panel after the wash cycle was then compared with the soiled weight thereof before the wash cycle to determine the percent soil removed. Zone LF, an acid detergent cleaner manufactured by DeLaval Inc., was used as a control.

### Detergent Foam Test (Dairy Pipe Line-CIP Cleaning System)

Detergent foaming is a concern especially for systems in which quick cleaning and rinsing cycles are important, particularly CIP systems having wash cycles of about 6-8 minutes. A series of trials were performed in order to optimize the level of foaming associated with the detergent formulations (i.e., reduce the level of foaming as much as possible).

The foaming trials were performed in a dynamic environment using a 1000 milliliter graduated cylinder, a shielded flowmeter tube from Gillmont Instruments (GF-1260), and an air pump from Thermo fisher (420-1901) or equivalent. Flexible tubing was connected from the outlet of the air pump through the flowrator tube and into the inlet of a porous sphere sparger (Saint-Gobain Ceramic (3590055A). The detergent solution was prepared and 300 mL was placed into the graduated cylinder. The air pump was set for a flow rate of 2.0 L/min and activated for 15 seconds. The initial net volume of foam (total volume minus the volume of liquid) was recorded. Measurements were periodically taken until complete foam collapse was achieved.

The tests were performed using both 300 ppm hard water (HD). Initially, a variety of single and dual surfactant systems were tested. As used herein, DNMC refers to dynamic foam height measured in mL in a dynamic foam height measurement.

In certain examples, the germicidal efficacy of several detergent formulations made in accordance with the present invention were determined by Basic Bactericidal Activity-European Standard EN 1040 and Bactericidal Activity of Chemical Disinfectants and Antiseptics used in Food, Industrial, Domestic, and Industrial Areas-European Standard EN 1276.

European Standard EN 1040 sets forth a suspension test method for establishing whether a chemical disinfectant or antiseptic meet certain minimum antimicrobial criteria when used at a recommended concentration. This standard is primarily directed toward agricultural products. If a product meets the minimum test requirements, for regulatory purposes, it is considered as possessing bactericidal functionality. The product must demonstrate a 10⁵ reduction (5 log reduction i.e., 99.999% reduction) in viable counts for Pseudomonas aeruginosa (ATCC 15442) and Staphylococcus aureus (ATCC 6538).

In this test, a suspension of bacteria was added to a prepared sample of the detergent formulation being tested. The mixture was maintained at 20° C. After a specified contact time (5 minutes), an aliquot was taken and the bactericidal action in this portion was immediately neutralized or suppressed by a validation method. (i.e., by a dilution-neutralization method). The neutralizing composition used comprised: 3 g lecithin, 30 g polysorbate 80, 5 g sodium thiosulphate, 1 g L-histidine chlorhydrate, 30 g saponine, QS of distilled water to 500 mL, 10 mL of 0.25 M phosphate buffer, and QS of distilled water to 1000 mL.

It is important to note that the EN 1040 test is performed at 20° C., whereas in actual practice in the field, the detergent compositions will be used at higher temperatures (preferably about 60° C.). Therefore, even though a detergent formulation does not pass the EN 1040 test, it may still produce a 5 log reduction in microbes when used at the higher temperature.

Another, more stringent standard for assessing the bactericidal activity of chemical disinfectants and antiseptics is European Standard EN 1276. This standard is generally applicable for the following areas: (a) processing, distribution, and retailing of food of animal origin (milk and milk products, meat and meat products, fish, seafood, and related products, eggs and egg products, animal feeds); (b) food of vegetable origin (beverages, fruits, vegetables and derivatives, flour, milling and baking, animal feeds); (c) institutional and domestic areas (catering establishments, public areas, schools, nurseries, shops, sports rooms, waste containers, hotels, dwellings, clinically non sensitive areas of hospitals, offices); and (d) other industrial applications (packaging material, biotechnology-yeast, proteins, enzymes, pharmaceutical, cosmetics and toiletries, textiles, space industry, computer industry).

For a product to be certified under this test procedure, the product must meet the following minimum criteria. When diluted in hard water (approximately 300 ppm) at 20° C. and upon a 5 minute exposure time, under clean conditions (0.3 g/L bovine albumin), or dirty conditions (3 g/L bovine albumin), the product must demonstrate a 10⁵ reduction (5 log reduction i.e., 99.999% reduction) in viable counts for four selected reference strains: Pseudomonas aeruginosa (ATCC 15442), Staphylococcus aureus (ATCC 6538), Escherichia coli (ATCC 10536), and Enterococcus hirae (ATCC 10541).

In performing this test, a suspension of bacteria was added to a prepared sample of the detergent formulation being tested. The mixture was maintained at 20° C. After a specified contact time (5 minutes), an aliquot was taken and the bactericidal action in this portion was immediately neutralized or suppressed by a validation method, (i.e., by a dilution-neutralization method). The neutralizing composition used comprised: 3 g lecithin, 30 g polysorbate 80, 5 g sodium thiosulphate, 1 g L-histidine chlorhydrate, 30 g saponine, QS of distilled water to 500 mL, 10 mL of 0.25 M phosphate buffer, and QS of distilled water to 1000 mL.

Certain formulations were also tested for physical stability at the time of making (TOM), and after storage for 3 weeks at both 25° C. and 45° C. Formulations were characterized as stable if at TOM were clear and homogenous. Samples were stored at 25° C. and 45° C. in a stability oven and once per week were examined. Samples were removed from the stability oven, set at room temperature 20-22° C. to equilibrate and then evaluated. If the sample was clear and homogenous it was assessed as “stable” and the stability record was marked as “Pass stability”. If the sample, at least at one of the temperatures investigated, was showing haziness, phase separation was assessed as “fail stability”.

| | Formulation | | | | | | | | |
|---|---|---|---|---|---|---|---|---|---|
| | 1 | 2 | 3 | 4 | 5 | 6 | 7 | 8 | 9 |
| | (wt. %) | (wt. %) | (wt. %) | (wt. %) | (wt. %) | (wt. %) | (wt. %) | (wt. %) | (wt. %) |
| Ingredients | | | | | | | | | |
| Deionized water | 64.1 | 63.93 | 65.25 | 64.88 | 67.35 | 62.6 | 62.7 | 62.8 | 62.9 |
| Plurafac LF220 | 8.8 | 9.6 | 8.4 | 8.4 | 6.3 | 10 | 10 | 10 | 10 |
| Plurafac SLF180 | — | 1.21 | 1.09 | — | — | — | — | — | — |
| Degressal SD20 | 1.8 | — | — | 1.5 | 1.1 | 1.9 | 1.9 | 1.8 | 1.8 |
| Ratio of LF220 | — | 7.9 | 7.7 | — | — | — | — | — | — |
| to SLF180 | | | | | | | | | |
| Ratio of LF220 | 4.9 | | | 5.6 | 5.7 | 5.3 | 5.3 | 5.6 | 5.6 |
| to SD20 | | | | | | | | | |
| Phosphoric acid 75% | 19.2 | 19.2 | 19.2 | 16 | 16 | 14.5 | 15.4 | 16.4 | 17.3 |
| Methanesulfonic acid | 6 | 6 | 6 | 9.2 | 9.2 | 11 | 10 | 9 | 8 |
| 70% | | | | | | | | | |
| sum of surfactants | 10.6 | 10.81 | 9.49 | 9.9 | 7.4 | 11.9 | 11.9 | 11.8 | 11.8 |
| sum of acid | 25.2 | 25.2 | 25.2 | 25.2 | 25.2 | 25.5 | 25.4 | 25.4 | 25.3 |
| component | | | | | | | | | |
| ratio of acid to | 2.4 | 2.3 | 2.7 | 2.5 | 3.4 | 2.1 | 2.1 | 2.2 | 2.1 |
| surfactant | | | | | | | | | |
| sum of acid | 35.8 | 36.01 | 34.69 | 35.1 | 32.6 | 37.4 | 37.3 | 37.2 | 37.1 |
| component and | | | | | | | | | |
| surfactant | | | | | | | | | |
| components | | | | | | | | | |
| Cleaning Performance | | | | | | | | | |
| Usage Concentration, | 4 | 4 | 4 | 4 | — | — | 4 | — | 4 |
| ml/L | | | | | | | | | |
| Wash Temperature, | 40/50/60 | 40/50/60 | 40/50/60 | 40/50/60 | — | — | 40/50/60 | — | 40/50/60 |
| ° C. | | | | | | | | | |
| Milk Soil % Cleaning/ | 100/96/98 | 100/98/94 | 99/100/95 | 93/91/94 | — | — | 97/98/94 | — | 96/98/96 |
| 300 ppm HW | | | | | | | | | |
| Control (Zone LF) % | 91/94/94 | 91/94/94 | 91/94/94 | 91/94/94 | — | — | 91/94/94 | — | 91/94/94 |
| Cleaning/300 ppm HW | | | | | | | | | |

| | Formulation | | | | | | | | |
|---|---|---|---|---|---|---|---|---|---|
| | 10 | 11 | 12 | 13 | 14 | 15 | 16 | 17 | 18 |
| | (wt. %) | (wt. %) | (wt. %) | (wt. %) | (wt. %) | (wt. %) | (wt. %) | (wt. %) | (wt. %) |
| Ingredients | | | | | | | | | |
| Deionized water | 66.4 | 55.3 | 65.75 | 54.45 | 67.07 | 56.81 | 66.35 | 55.24 | 56.88 |
| Plurafac LF220 | 7.00 | 9.31 | 8.40 | 11.17 | 7.20 | 9.58 | 7.34 | 9.76 | 8.36 |
| Plurafac SLF180 | — | — | 0.85 | 1.13 | 0.73 | 0.97 | — | — | — |
| Degressal SD20 | 1.61 | 2.141 | — | — | — | — | 1.32 | 1.75 | 1.50 |
| Ratio of LF220 | 4.3 | 4.3 | — | — | — | — | 5.6 | 5.6 | 5.6 |
| to SD20 | | | | | | | | | |
| Phosphoric acid 75% | 20.00 | 26.6 | 20 | 26.6 | 20 | 26 | 21 | 27.93 | 27.93 |
| Methanesulfonic acid | 5.00 | 6.65 | 5 | 6.65 | 5 | 6.65 | 4 | 5.32 | 5.32 |
| 70% | | | | | | | | | |
| Citric acid, anhydrous | — | — | — | — | — | — | 4 | — | — |
| sum of surfactants | 8.61 | 11.45 | 9.25 | 12.30 | 7.93 | 10.54 | 8.66 | 11.51 | 9.86 |
| sum of acid | 25 | 33.25 | 25 | 33.25 | 25 | 32.65 | 25 | 33.25 | 33.25 |
| component | | | | | | | | | |
| ratio of acid to | 2.9 | 2.9 | 2.7 | 2.7 | 3.2 | 3.1 | 2.9 | 2.9 | 3.4 |
| surfactant | | | | | | | | | |
| sum of acid | 33.61 | 44.70 | 34.25 | 45.55 | 32.93 | 43.19 | 33.66 | 44.76 | 43.11 |
| component and | | | | | | | | | |
| surfactant | | | | | | | | | |
| components | | | | | | | | | |
| FD&C Red 40 | 0.0025 | 0.0033 | 0.0025 | 0.0033 | 0.0025 | 0.0033 | 0.0025 | 0.0033 | 0.0033 |
| pH, 1% in deionized | 2.21 | 2.02 | 2.17 | — | 2.17 | — | 2.13 | — | — |
| water | | | | | | | | | |
| Cleaning Performance | | | | | | | | | |
| Usage Concentration, | 4 | 3 | 4 | 3 | 4 | 3 | 4 | 3 | 3 |
| ml/L | | | | | | | | | |
| Wash Temperature, | 40/50/60 | 40/50/60 | 40/50/60 | 40/50/60 | 40/50/60 | 40/50/60 | 40/50/60 | 40/50/60 | 40/50/60 |
| ° C. | | | | | | | | | |
| Milk Soil % Cleaning/ | 100/100/ | 99/98/ | 100/100/ | 100/99/ | 100/100/ | 99/100/ | 100/100/ | 100/100/ | 100/100/ |
| 300 ppm HW | 100 | 100 | 100 | 100 | 100 | 100 | 100 | 100 | 100 |
| Control (Zone LF) % | 100/100/ | 100/100/ | 100/100/ | 100/100/ | 100/100/ | 100/100/ | 100/100/ | 100/100/ | 100/100/ |
| Cleaning/300 ppm HW | 99 | 99 | 99 | 99 | 99 | 99 | 99 | 99 | 99 |

| | Formulation | | | | | | | |
|---|---|---|---|---|---|---|---|---|
| | 19 | 20 | 21 | 22 | 23 | 24 | 25 | 26 |
| | (wt. %) | (wt. %) | (wt. %) | (wt. %) | (wt. %) | (wt. %) | (wt. %) | (wt. %) |
| Ingredients | | | | | | | | |
| Deionized water | 67.58 | 68.63 | 68.82 | 69.44 | 70.05 | 71.11 | 71.91 | 72.52 |
| Plurafac LF220 | 6.29 | 5.24 | 5.24 | 4.72 | 4.19 | 3.14 | 2.62 | 2.1 |
| Plurafac SLF180 | — | — | — | — | — | — | — | — |
| Degressal SD20 | 1.13 | 1.13 | 0.94 | 0.85 | 0.75 | 0.75 | 0.47 | 0.38 |
| Ratio of LF220 | 5.6 | 4.6 | 5.6 | 5.6 | 5.6 | 4.2 | 5.6 | 5.5 |
| to SD20 | | | | | | | | |
| Phosphoric acid 75% | — | 21 | — | 21 | 21 | 21 | 21 | 21 |
| Methanesulfonic acid | 21 | 4.00 | 21 | 4 | 4 | 4 | 4 | 4 |
| 70% | | | | | | | | |
| Citric acid, anhydrous | 4 | — | 4 | — | — | — | — | — |
| sum of surfactants | 7.42 | 6.37 | 6.18 | 5.57 | 4.94 | 3.89 | 3.09 | 2.48 |
| sum of acid | 25 | 25 | 25 | 25 | 25 | 25 | 25 | 25 |
| component | | | | | | | | |
| ratio of acid to | 3.4 | 3.9 | 4.0 | 4.5 | 5.1 | 6.4 | 8.1 | 10.1 |
| surfactant | | | | | | | | |
| sum of acid | 32.42 | 31.37 | 31.18 | 30.57 | 29.94 | 28.89 | 28.09 | 27.48 |
| component and | | | | | | | | |
| surfactant | | | | | | | | |
| components | | | | | | | | |
| FD&C Red 40 | 0.0025 | 0.0025 | 0.0025 | 0.0025 | 0.0025 | 0.0025 | 0.0025 | 0.0025 |
| pH, 1% in deionized | 2.11 | — | — | — | — | — | — | — |
| water | | | | | | | | |
| Cleaning Performance | | | | | | | | |
| Usage Concentration, | 4 | 4 | 4 | 4 | 4 | 4 | 4 | 4 |
| ml/L | | | | | | | | |
| Wash Temperature, | 40/50/60 | 40/50 | 40/50 | 40/50 | 40/50 | 40/50 | 40/50 | 40/50 |
| ° C. | | | | | | | | |
| Milk Soil % Cleaning/ | 100/100/100 | 92/93 | 92/89 | 93/89 | 90/85 | 89/86 | 94/92 | 94/91 |
| 300 ppm HW | | | | | | | | |
| Control (Zone LF) % | 100/100/99 | 89/89 | 89/89 | 89/89 | 89/89 | 89/89 | 91/95 | 91/95 |
| Cleaning/300 ppm HW | | | | | | | | |
| Foam Performance | | | | | | | | |
| Usage dose mL/L | 4 | 4 | 4 | 4 | 4 | 4 | 4 | 4 |
| Foam Bath Temperature, | 45 | 45 | 45 | 45 | 45 | 45 | 45 | 45 |
| ° C. | | | | | | | | |
| Foam Collapse at | 100 | 100 | 100 | 100 | 100 | 100 | 100 | 100 |
| 5 minutes, % | | | | | | | | |

| | Formulation | | | | | | | | |
|---|---|---|---|---|---|---|---|---|---|
| | 27 | 28 | 29 | 30 | 31 | 32 | 33 | 34 | 35 |
| | (wt. %) | (wt. %) | (wt. %) | (wt. %) | (wt. %) | (wt. %) | (wt. %) | (wt. %) | (wt. %) |
| Ingredients | | | | | | | | | |
| Deionized water | 73.61 | 72.61 | 66.61 | 62.61 | 69.61 | 67.61 | 65.61 | 70.93 | 69.93 |
| Plurafac LF220 | 3.14 | 3.14 | 3.14 | 3.14 | 3.14 | 3.14 | 3.14 | 4.72 | 4.72 |
| Degressal SD20 | 0.75 | 0.75 | 0.75 | 0.75 | 0.75 | 0.75 | 0.75 | 0.85 | 0.85 |
| Ratio of LF220 | 4.2 | 4.2 | 4.2 | 4.2 | 4.2 | 4.2 | 4.2 | 5.6 | 5.6 |
| to SD20 | | | | | | | | | |
| Methanesulfonic acid | 8 | 12.5 | 12.5 | 12.5 | 12.5 | 12.5 | 12.5 | 12.5 | 12.5 |
| 70% | | | | | | | | | |
| Lactic acid 88% | 14.5 | 11 | — | — | 11 | 11 | 11 | 11 | 11 |
| Glycolic acid 70% | — | — | 14 | 14 | — | — | — | — | — |
| sum of surfactants | 3.89 | 3.89 | 3.89 | 3.89 | 3.89 | 3.89 | 3.89 | 5.57 | 5.57 |
| sum of acid | 22.5 | 23.5 | 26.5 | 26.5 | 23.5 | 23.5 | 23.5 | 23.5 | 23.5 |
| component | | | | | | | | | |
| ratio of acid to | 5.8 | 6.0 | 6.8 | 6.8 | 6.0 | 6.0 | 6.0 | 4.2 | 4.2 |
| surfactant | | | | | | | | | |
| sum of acid | 26.39 | 27.39 | 30.39 | 30.39 | 27.39 | 27.39 | 27.39 | 29.07 | 29.07 |
| component and | | | | | | | | | |
| surfactant | | | | | | | | | |
| components | | | | | | | | | |
| Propylene glycol | — | — | 3 | 7 | 3 | 5 | 7 | — | 1 |
| pH, 1% in deionized | — | 2.17 | — | — | — | 2.21 | — | 2.12 | — |
| water | | | | | | | | | |
| Cleaning Performance | | | | | | | | | |
| Usage Concentration, ml/L | — | 4 | — | — | — | 4 | — | — | — |
| Wash Temperature, ° C. | — | 40/50/60 | — | — | — | 40/50/60 | — | — | — |
| Milk Soil % Cleaning/ | — | 94/91/88 | — | — | — | 93/94/90 | — | — | — |
| 300 ppm HW | | | | | | | | | |
| Control (Zone LF) % | — | 94/91 | — | — | — | 98/98/92 | — | — | — |
| Cleaning/300 ppm HW | | | | | | | | | |
| Foam Performance | | | | | | | | | |
| Usage dose mL/L | — | 5 | — | — | — | — | — | 5 | — |
| Foam Bath Temperature, | — | 40 | — | — | — | — | — | 40 | — |
| ° C. | | | | | | | | | |
| Foam Collapse at | — | 100 | — | — | — | — | — | 100 | — |
| 5 minutes, % | | | | | | | | | |
| | Formulation | | | | | | | | |
| | 36 | 37 | 38 | 39 | 40 | 41 | 42 | 43 | 44 |
| | (wt. %) | (wt. %) | (wt. %) | (wt. %) | (wt. %) | (wt. %) | (wt. %) | (wt. %) | (wt. %) |
| Ingredients | | | | | | | | | |
| Deionized water | 67.93 | 65.93 | 63.93 | 67.93 | 64.93 | 62.93 | 60.93 | 68.13 | 66.13 |
| Plurafac LF220 | 4.72 | 4.72 | 4.72 | 4.72 | 4.72 | 4.72 | 4.72 | 4.72 | 4.72 |
| Degressal SD20 | 0.85 | 0.85 | 0.85 | 0.85 | 0.85 | 0.85 | 0.85 | 0.85 | 0.85 |
| Ratio of LF220 | 5.6 | 5.6 | 5.6 | 5.6 | 5.6 | 5.6 | 5.6 | 5.6 | 5.6 |
| to SD20 | | | | | | | | | |
| Methanesulfonic acid | 12.5 | 12.5 | 12.5 | 12.5 | 12.5 | 12.5 | 12.5 | 12.5 | 12.5 |
| 70% | | | | | | | | | |
| Lactic acid 88% | 11 | 11 | 11 | — | — | — | — | — | — |
| Glycolic acid 70% | — | — | — | 14 | 14 | 14 | 14 | — | — |
| Citric acid Anhydrous | — | — | — | — | — | — | — | 10.8 | 10.8 |
| sum of surfactants | 5.57 | 5.57 | 5.57 | 5.57 | 5.57 | 5.57 | 5.57 | 5.57 | 5.57 |
| sum of acid | 23.5 | 23.5 | 23.5 | 26.5 | 26.5 | 26.5 | 26.5 | 23.3 | 23.3 |
| component | | | | | | | | | |
| ratio of acid to | 4.2 | 4.2 | 4.2 | 4.8 | 4.8 | 4.8 | 4.8 | 4.2 | 4.2 |
| surfactant | | | | | | | | | |
| sum of acid | 29.07 | 29.07 | 29.07 | 32.07 | 32.07 | 32.07 | 32.07 | 28.87 | 28.87 |
| component and | | | | | | | | | |
| surfactant | | | | | | | | | |
| components | | | | | | | | | |
| Propylene glycol | 3 | 5 | 7 | — | 3 | 5 | 7 | 3 | 5 |
| pH, 1% in deionized | — | 2.19 | — | — | — | 2.15 | — | — | — |
| water | | | | | | | | | |
| Cleaning Performance | | | | | | | | | |
| Usage Concentration, ml/L | — | 4 | — | — | — | 4 | — | — | — |
| Wash Temperature, ° C. | — | 40/50/60 | — | — | — | 40/50/60 | — | — | — |
| Milk Soil Cleaning/ | — | 93/93/88 | — | — | — | 96/86/94 | — | — | — |
| 300 ppm, % | | | | | | | | | |
| Control - Zone LF, % | — | 98/98/92 | — | — | — | 98/98/92 | — | — | — |

| | Formulation | | | | | | | | |
|---|---|---|---|---|---|---|---|---|---|
| | 45 | 46 | 47 | 48 | 49 | 50 | 51 | 52 | 53 |
| | (wt. %) | (wt. %) | (wt. %) | (wt. %) | (wt. %) | (wt. %) | (wt. %) | (wt. %) | (wt. %) |
| Ingredients | | | | | | | | | |
| Deionized water | 64.13 | 69.43 | 69.93 | 68.93 | 30.85 | 55.15 | 40.86 | 26.57 | 66.84 |
| Plurafac LF220 | 4.72 | 4.72 | 4.72 | 4.72 | 4.72 | 4.72 | 4.72 | 4.72 | 4.72 |
| Degressal SD20 | 0.85 | 0.85 | 0.85 | 0.85 | 0.85 | 0.85 | 0.85 | 0.85 | 0.85 |
| Ratio of LF220 | 5.6 | 5.6 | 5.6 | 5.6 | 5.6 | 5.6 | 5.6 | 5.6 | 5.6 |
| to SD20 | | | | | | | | | |
| Phosphoric acid 75% | — | — | — | — | — | — | — | — | 21 |
| Methanesulfonic acid | 12.5 | 21 | 17 | 21 | 17.59 | 21 | 21 | 21 | 4 |
| 70% | | | | | | | | | |
| Acetic acid | — | 4 | — | — | 23.3 | — | — | — | — |
| Citric acid Anhydrous | 10.8 | — | 7 | 4 | — | 4 | 4 | 4 | — |
| sum of surfactants | 5.57 | 5.57 | 5.57 | 5.57 | 5.57 | 5.57 | 5.57 | 5.57 | 5.57 |
| sum of acid | 23.3 | 25 | 24 | 25 | 45.59 | 25 | 25 | 25 | 25 |
| component | | | | | | | | | |
| ratio of acid to | 4.2 | 4.5 | 4.3 | 4.5 | 8.2 | 4.5 | 4.5 | 4.5 | 4.5 |
| surfactant | | | | | | | | | |
| sum of acid | 28.87 | 30.57 | 29.57 | 30.57 | 51.16 | 30.57 | 30.57 | 30.57 | 30.57 |
| component and | | | | | | | | | |
| surfactant | | | | | | | | | |
| components | | | | | | | | | |
| Hydrogen Peroxide, 35% | — | — | — | — | 11.6 | 14.29 | 28.58 | 42.87 | — |
| & 50% | | | | | | | | | |
| Peracetic acid | | | | | 6 | | | | |
| (generated in situ) | | | | | | | | | |
| 1-hydroxyethane 1,1- | — | — | — | — | 1 | — | — | — | — |
| diphosphonic acid | | | | | | | | | |
| 60% HEDP | | | | | | | | | |
| Clean Front, HI/I₂ | — | — | — | — | — | — | — | — | 2.8 |
| C9-C11 alcohol | | | | | | | | | 1.75 |
| ethoxylate | | | | | | | | | |
| Iodine | | | | | | | | | 0.6 |
| HI | | | | | | | | | 0.24 |
| Propylene glycol | 7 | | — | | — | — | — | — | — |
| pH, 1% in deionized | 2.13 | 2.06 | — | 2.01 | — | — | — | — | — |
| water | | | | | | | | | |
| Cleaning Performance | | | | | | | | | |
| Usage Concentration, ml/L | 4 | 4 | — | 4 | — | — | — | — | — |
| Wash Temperature, ° C. | 40/50/60 | 40/50/60 | — | 40/50/60 | — | — | — | — | — |
| Milk Soil Cleaning/ | 98/91/95 | 94/95/90 | — | 95/93/90 | — | — | — | — | — |
| 300 ppm, % | | | | | | | | | |
| Control - Zone LF, | 98/98/92 | 97/97/92 | — | 97/97/92 | — | — | — | — | — |
| cleaning % | | | | | | | | | |
| Foam Performance | | | | | | | | | |
| Usage dose mL/L | — | 5 | — | 5 | — | — | — | — | — |
| Foam Bath Temperature, | — | 40 | — | 40 | — | — | — | — | — |
| ° C. | | | | | | | | | |
| Foam Collapse at | — | 100 | — | 100 | — | — | — | — | — |
| 5 minutes, % | | | | | | | | | |

| | Formulation | | | | | | | | |
|---|---|---|---|---|---|---|---|---|---|
| | 54 | 55 | 56 | 57 | 58 | 59 | 60 | 61 | 62 |
| Ingredients | (wt. %) | (wt. %) | (wt. %) | (wt. %) | (wt. %) | (wt. %) | (wt. %) | (wt. %) | (wt. %) |
| Water | 69.8 | 61.1 | 54.4 | 56.5 | 75.5 | 68.9 | 63.8 | 65.9 | 60.9 |
| Plurafac LF220 | 4.72 | 4.72 | 4.72 | 3 | 4.72 | 4.72 | 4.72 | 3 | 11 |
| Degressal SD20 | 0.85 | 0.85 | 0.85 | 0.54 | 0.85 | 0.85 | 0.85 | 0.54 | 2.3 |
| Phosphoric Acid 75% | 24.6 | 33.3 | 40 | 40 | — | — | — | — | 12.4 |
| Sulfuric Acid 98% | — | — | — | — | 18.9 | 25.5 | 30.6 | 30.6 | 13.4 |
| Nitric Acid 68% | — | — | — | — | — | — | — | — | — |
| Methanesulfonic Acid | — | — | — | — | — | — | — | — | — |
| 70% | | | | | | | | | |
| Surfactant S1:S2 ratio | 5.6 | 5.6 | 5.6 | 5.6 | 5.6 | 5.6 | 5.6 | 5.6 | 4.8 |
| Acid:SurfactantS Ratio | 4.4 | 6.0 | 7.2 | 11.3 | 3.4 | 4.6 | 5.5 | 8.6 | 1.9 |
| Sum Acid + Surfactants | 30.2 | 38.9 | 45.6 | 43.5 | 24.5 | 31.1 | 36.2 | 34.1 | 39.1 |
| Stability TOM 25 C. | Pass | Pass | Pass | Pass | Pass | Pass | Pass | Pass | Pass |
| Pass/Fail | | | | | | | | | |
| Stability 25 C. Pass/Fail | Pass | Pass | Pass | Pass | Pass | Pass | Pass | Pass | Pass |
| Stability 45 C. Pass/Fail | Pass | Pass | Pass | Pass | Pass | Pass | Pass | Pass | Pass |
| Wash Temperature, ° C. | 40 | 40 | 40 | 40 | 40 | 40 | 40 | 40 | 40 |
| Milk Soil % Cleaning/ | 97 | 97 | 99 | 97 | 41 | 44 | 56 | 47 | 100 |
| 300 ppm HW | | | | | | | | | |
| Control (Zone LF) % | | | | | | | | | |
| Cleaning/300 ppm HW | | | | | | | | | |
| Dynamic Foam Test, | 350-0-0 | 350-0-0 | 400-0-0 | 500-0-0 | 550-0-0 | 400-0-0 | 450-0-0 | 570-0-0 | 250-0-0 |
| foam height (mL), | | | | | | | | | |
| 0.5% v/v, 45 C., | | | | | | | | | |
| 300 ppm HW (0 sec, | | | | | | | | | |
| 30 sec, 1 min) | | | | | | | | | |

| | Formulation | | | | | | | | | |
|---|---|---|---|---|---|---|---|---|---|---|
| | 63 | 64 | 65 | 66 | 67 | 68 | 69 | 70 | 71 | 72 |
| Ingredients | (wt. %) | (wt. %) | (wt. %) | (wt. %) | (wt. %) | (wt. %) | (wt. %) | (wt. %) | (wt. %) | (wt. %) |
| Water | 61.2 | 61.7 | 62.2 | 62.7 | 0.0 | 0.0 | 0.0 | 0.0 | 0.0 | 0.0 |
| Plurafac LF220 | 11 | 11 | 11 | 11 | 4.72 | 4.72 | 2.1 | 2.1 | 2.1 | 4.72 |
| Degressal SD20 | 2 | 1.5 | 1 | 0.5 | 0.85 | 0.85 | 0.38 | 0.38 | 0.38 | 0.85 |
| Phosphoric Acid 75% | 12.4 | 12.4 | 12.4 | 12.4 | 80 | 94.43 | 83 | 97.52 | | 0 |
| Sulfuric Acid 98% | 13.4 | 13.4 | 13.4 | 13.4 | — | 0 | — | — | 97.52 | — |
| Nitric Acid 68% | — | — | — | — | — | — | — | — | — | — |
| Methanesulfonic Acid | — | — | — | — | 14.43 | — | 14.52 | — | — | 94.43 |
| 70% | | | | | | | | | | |
| Surfactant S1:S2 ratio | 5.5 | 7.3 | 11.0 | 22.0 | 5.6 | 5.6 | 5.5 | 5.5 | 5.5 | 5.6 |
| Acid:SurfactantS Ratio | 2.0 | 2.1 | 2.2 | 2.2 | 17.0 | 17.0 | 39.3 | 39.3 | 39.3 | 17.0 |
| Sum Acid + Surfactants | 38.8 | 38.3 | 37.8 | 37.3 | 100.0 | 100.0 | 100.0 | 100.0 | 100.0 | 100.0 |
| Stability TOM 25 C. | Pass | Pass | Pass | Pass | Pass | Pass | Pass | Pass | Pass | Pass |
| Pass/Fail | | | | | | | | | | |
| Stability 25 C. Pass/Fail | Pass | Pass | Pass | Pass | Pass | Pass | Pass | Pass | Pass | Pass |
| Stability 45 C. Pass/Fail | Pass | Pass | Pass | Pass | Pass | Pass | Pass | Pass | Pass | Pass |
| Wash Temperature, ° C. | 40 | 40 | 40 | 40 | 40 | 40 | 40 | 40 | 40 | 40 |
| Milk Soil % Cleaning/ | 100 | 100 | 100 | 100 | 100 | 100 | 100 | 100 | 96 | 98 |
| 300 ppm HW | | | | | | | | | | |
| Control (Zone LF) % | | | | | | | | | | |
| Cleaning/300 ppm HW | | | | | | | | | | |
| Dynamic Foam Test, | 350-0-0 | 500-0-0 | 500-0-0 | 600-550- | 600-30-0 | 500-20-0 | 650-60-0 | 650-100-0 | 600-100-0 | 400-0-0 |
| foam height (ml), | | | | 400 | | | | | | |
| 0.5% v/v, 45 C., | | | | | | | | | | |
| 300 ppm HW (0 sec, | | | | | | | | | | |
| 30 sec, 1 min) | | | | | | | | | | |

| | Formulation | | | | | | | | | | | |
|---|---|---|---|---|---|---|---|---|---|---|---|---|
| | 73 | 74 | 75 | 76 | 77 | 78 | 79 | 80 | 81 | 82 | 83 | 84 |
| | % | % | % | % | % | % | % | % | % | % | % | % |
| Ingredients | | | | | | | | | | | | |
| Water | 69.2 | 67.3 | 47.4 | 37.4 | 42.9 | 66.6 | 63.9 | 69.3 | 69.1 | 69.0 | 68.2 | 69.9 |
| Plurafac LF220 | 4.72 | 7.007 | 6.3 | 6.3 | 6.3 | 7.08 | 9.44 | 4.72 | 4.72 | 4.72 | 4.72 | 4.72 |
| Plurafac LF180 | | | | | | 1.28 | 1.7 | 0.95 | 1.15 | 1.25 | 2.1 | 0.95 |
| Degressal SD20 | 1.05 | 1.42 | 1.3 | 1.3 | 1.3 | | | | | | | |
| Phoshoric Acid 75% | | | | | | | | | | | | |
| Sulfuric Acid 98% | | | | | 22.5 | | | | | | | |
| Nitric Acid 68% | | | | | | | | | | | | |
| Methanesulfonic Acid | 21.0 | 14.8 | 45.0 | 30.0 | 27.0 | 21 | 21 | 21 | 21.0 | 21 | 21 | 14.86 |
| 70% | | | | | | | | | | | | |
| Citric Acid | 4.0 | 9.5 | | 25.0 | | 4 | 4 | 4 | 4.0 | 4 | 4 | 9.58 |
| Surfactant S1:S2 ratio | 4.5 | 4.9 | 4.8 | 4.8 | 4.8 | 5.6 | 5.6 | 5.0 | 4.1 | 3.8 | 2.2 | 5.0 |
| Acid:Surfactants Ratio | 4.3 | 2.9 | 5.9 | 7.2 | 6.5 | 3.0 | 2.2 | 4.4 | 4.3 | 4.2 | 3.7 | 4.3 |
| Sum Acid + Surfactants | 30.8 | 32.7 | 52.6 | 62.6 | 57.1 | 28.1 | 30.4 | 25.7 | 30.9 | 31.0 | 31.8 | 30.1 |
| Stability TOM 25 C. | Pass | Pass | Pass | Pass | Pass | Pass | Pass | Pass | Pass | Pass | Pass | Pass |
| Pass/Fail | | | | | | | | | | | | |
| Stability 25 C. Pass/Fail | Pass | Pass | Pass | Pass | Pass | Pass | Pass | Pass | Pass | Pass | Pass | Pass |
| Stability 45 C. Pas/Fail | Pass | Pass | Pass | Pass | Pass | Pass | Pass | Pass | Pass | Pass | Pass | Pass |
| Cleaning Performance | | | | | | | | | | | | |
| Usage Concentration | 4 | 4 | 3 | 3 | 3 | | | | 4 | 4 | 4 | 4 |
| mL/L | | | | | | | | | | | | |
| Temperature ° C. | 50° C. | 50° C. | 50° C. | 50° C. | 50° C. | | | | 50° C. | 50° C. | 50° C. | 50° C. |
| Milk Soil Cleaning/ | 93 | 93 | 93 | 92 | 58 | | | | 89 | 92 | 84 | 89 |
| 300 ppm HW, % | | | | | | | | | | | | |
| Zone, control soil | 90 | 90 | 90 | 90 | 90 | | | | 90 | 90 | 90 | 90 |
| cleaning | | | | | | | | | | | | |
| Foam Dynamic Foam | 590-250-0 | 540-100-0 | 540-90-0 | 550-165-0 | | | | | 590-540- | 590-490- | | 590-515- |
| Test 0.4% v/v %, | | | | | | | | | 350 | 225 | | 225 |
| 45 C., 300 ppm HW | | | | | | | | | | | | |
| ( 0-30 sec-1 minute) | | | | | | | | | | | | |

Foaming characteristics of certain formulations prepared in accordance with the present invention were compared with a commercially available product, Zone LF acid detergent cleaner, available from West Agro Inc. As can be seen from the data presented in Table 3, below, the Zone LF detergent exhibited high levels of initial foaming at 0.4% v/v concentrations at 45° C., and at 0.5% v/v concentrations at temperatures ranging from 25° C. to 65° C., which generally did not fully collapse until more than a minute had elapsed. However, for those exemplary formulations according to the present invention that were tested, total foam collapse occurred relatively quickly at temperatures in excess of 45° C. In most cases, at higher temperatures, the foam completely (or almost completely) collapsed within 30 seconds.

Germicidal efficacy data for certain formulations prepared in accordance with the present invention is presented in Table 4, below. Generally, the tested formulations were effective in reducing microbial counts for at least some, if not all, of the bacteria tested.

TABLE 3

| | | Formulation | | | | | |
|---|---|---|---|---|---|---|---|
| Test Conditions | Zone LF | 22 | 68 | 69 | 70 | 71 | 72 |
| Dynamic Foam Test, 0.4% | 575-510-450-0 | — | — | — | — | — | — |
| v/v %, 45 C., 300 ppm HW | 615-540-480-25 | | | | | | |
| (0-30 sec-1 min-5 min) | | | | | | | |
| (two runs) | | | | | | | |
| Dynamic Foam Test, 0.4% | 585-535-420-0 | — | 500-20-0-0 | 650-60-0-0 | 650-100-0-0 | 600-100-0-0 | 400-0-0-0 |
| v/v %, 45 C., 300 ppm HW | | | | | | | |
| (0-30 sec-1 min-5 min) | | | | | | | |
| Dynamic Foam Test, 0.5% | 640-580-530-0 | — | — | — | — | — | — |
| v/v %, 40 C., 300 ppm HW | | | | | | | |
| (0-30 sec-1 min-5 min) | | | | | | | |
| Dynamic Foam Test 0.5% | 600-475-340-40 | 560-340-65-10 | — | — | — | — | — |
| v/v, 25 C., 300 ppm HW | | | | | | | |
| (0-30 sec-1 min-5 min) | | | | | | | |
| Dynamic Foam Test 0.5% | 630-590-525-0 | 400-0-0-0 | — | — | — | — | — |
| v/v, 45 C., 300 ppm HW | | | | | | | |
| (0-30 sec-1 min-5 min) | | | | | | | |
| Dynamic Foam Test 0.5% | 540-265-0-0 | 100-0-0-0 | — | — | — | — | — |
| v/v, 65 C., 300 ppm HW | | | | | | | |
| (0-30 sec-1 min-5 min) | | | | | | | |
| Dynamic Foam Test 1.5% | 620-600-550-20 | 590-490-350-10 | — | — | — | — | — |
| v/v, 25 C., 300 ppm HW | | | | | | | |
| (0-30 sec-1 min-5 min) | | | | | | | |
| Dynamic Foam Test 1.5% | 700-640-440-10 | 390-10-0-0 | — | — | — | — | — |
| v/v, 45 C., 300 ppm HW | | | | | | | |
| (0-30 sec-1 min-5 min) | | | | | | | |
| Dynamic Foam Test 1.5% | 700-610-200-10 | 400-0-0-0 | — | — | — | — | — |
| v/v, 65 C., 300 ppm HW | | | | | | | |
| (0-30 sec-1 min-5 min) | | | | | | | |

TABLE 4

| | Formulation (log reduction) | | | | |
|---|---|---|---|---|---|
| Germicidal Efficacy Test | 49 | 50 | 51 | 52 | 53 |

EN1040, 0.5% v/v dose, 5 minutes
contact, 20 C.

| P. Aeruginosa | 6.3 | — | — | — | — |
|---|---|---|---|---|---|
| S. Aureus | 6.3 | — | — | — | — |
| EN1276, 0.5% v/v dose, 5 minutes | | | | | |
| contact, clean conditions 20 C. | | | | | |
| S. Aureus | 6.3 | — | — | — | — |
| E Coli | 6.2 | — | — | — | — |
| P. Aeruginosa | 6.3 | — | — | — | — |
| E. Hirae | 6.6 | — | — | — | — |
| EN1040, 0.4% v/v dose, 5 minutes | | | | | |
| contact, 20 C. | | | | | |
| P. Aeruginosa | 6.3 | 6.1 | 5.3 | 6.1 | — |
| S. Aureus | 6.3 | 4.5 | 4.7 | 6.5 | — |
| EN1276, 0.4% v/v dose, 5 minutes | | | | | |
| contact, clean conditions 20 C. | | | | | |
| S. Aureus | 6.3 | 4.1 | 4.3 | 6.5 | — |
| E Coli | 6.2 | 5.1 | 6.2 | 6.2 | — |
| P. Aeruginosa | 6.3 | 6.1 | 6.1 | 6.1 | — |
| E. Hirae | 6.6 | 3.3 | 3.5 | 3.7 | — |
| EN1040, 0.4% v/v dose, 5 minutes | | | | | |
| contact, 30 C. | | | | | |
| P. Aeruginosa | 5.7 | 4.4 | 5.7 | 5.7 | 5.7 |
| S. Aureus | 6.4 | 0.5 | 4.3 | 6.4 | 6.4 |
| EN1276, 0.4% v/v dose, 5 minutes | | | | | |
| contact, clean conditions 30 C. | | | | | |
| S. Aureus | 6.4 | 1 | 0.7 | 3.3 | 6.4 |
| E Coli | 6.4 | 3.9 | 5.3 | 4.4 | 6.4 |
| P. Aeruginosa | 5.7 | 5.7 | 5.7 | 5.2 | 5.7 |
| E. Hirae | 6.3 | 0.8 | 0.3 | 0.8 | 6.3 |
| EN1040, 0.3% v/v dose, 5 minutes | | | | | |
| contact, 30 C. | | | | | |
| P. Aeruginosa | 6.4 | — | — | — | — |
| S. Aureus | 5.7 | — | — | — | — |
| EN1276, 0.3% v/v dose, 5 minutes | | | | | |
| contact, clean conditions 30 C. | | | | | |
| S. Aureus | 6.4 | — | — | — | — |
| E Coli | 6.4 | — | — | — | — |
| P. Aeruginosa | 5.7 | — | — | — | — |
| E. Hirae | 6.3 | — | — | — | — |
| EN1040, 0.2% v/v dose, 5 minutes | | | | | |
| contact, 30 C. | | | | | |
| P. Aeruginosa | 6.4 | — | — | — | — |
| S. Aureus | 5.7 | — | — | — | — |
| EN1276, 0.2% v/v dose, 5 minutes | | | | | |
| contact, clean conditions 30 C. | | | | | |
| S. Aureus | 6.4 | — | — | — | — |
| E Coli | 6.4 | — | — | — | — |
| P. Aeruginosa | 5.7 | — | — | — | — |
| E. Hirae | 6.3 | — | — | — | — |
| EN1040, 0.1% v/v dose, 5 minutes | | | | | |
| contact, 30 C. | | | | | |
| P. Aeruginosa | 6.4 | — | — | — | — |
| S. Aureus | 5.7 | — | — | — | — |
| EN1276, 0.1% v/v dose, 5 minutes | | | | | |
| contact, clean conditions 30 C. | | | | | |
| S. Aureus | 6.4 | — | — | — | — |
| E Coli | 6.4 | — | — | — | — |
| P. Aeruginosa | 5.7 | — | — | — | — |
| E. Hirae | 6.3 | — | — | — | — |

Additional advantages of the various embodiments of the invention will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments, but is not necessarily included. Thus, the present invention encompasses a variety of combinations and/or integrations of the specific embodiments described herein.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

1. A concentrated detergent composition comprising:
an acidic component comprising an alkanesulfonic acid and optionally an additional acid that is different than said alkanesulfonic acid;
a first surfactant comprising a non-ionic surfactant selected from the group consisting of C6-C20 alcohol ethoxylates; and
a second surfactant comprising a C6-C20 alcohol ethoxylate that is different than said first surfactant,
the weight ratio of said first surfactant to said second surfactant in said composition being from about 2.2:1 to about 22:1,
the weight ratio of said acidic component to the sum of said first and second surfactants being from about 2:1 to about 40:1,
said acid component and said first and second surfactants collectively comprising from about 5% to about 100% by weight of said composition,
wherein said composition does not comprise a fatty alkyl-1,3-diaminopropane component.

2. The concentrated detergent composition according to claim 1, wherein said alkanesulfonic acid is present at a level of from about 1% to about 98% by weight.

3. The concentrated detergent composition according to claim 1, wherein said alkanesulfonic acid comprises methanesulfonic acid.

4. The concentrated detergent composition according to claim 1, wherein said additional acid that is different than said alkanesulfonic acid is selected from the group consisting of phosphoric acid, sulfuric acid, lactic acid, glycolic acid, formic acid, acetic acid, citric acid, and gluconic acid.

5. (canceled)

6. (canceled)

7. The concentrated detergent composition according to claim 1, wherein said composition further comprises an antimicrobial agent.

8. The concentrated detergent composition according to claim 7, wherein said antimicrobial agent is hydrogen peroxide, iodine, or combinations thereof.

9. The concentrated detergent composition according to claim 8, wherein said additional acid comprises an organic acid that is different than said alkanesulfonic acid, said antimicrobial agent comprises hydrogen peroxide, said organic acid and said hydrogen peroxide react to generate a peracid.

10. The concentrated detergent composition according to claim 9, wherein said peracid is peracetic acid.

11. The concentrated detergent composition according to claim 1, wherein said composition further comprises a metal ion chelating agent.

12. The concentrated detergent composition according to claim 11, wherein said metal ion chelating agent is present within said composition at a level of from about 0.5% to about 2% by weight.

13. The concentrated detergent composition according to claim 11, wherein said metal ion chelating agent is 1-hydroxyethane 1,1-diphosphonic acid.

14. The concentrated detergent composition according to claim 1, wherein said concentrate further comprises an organic solvent.

15. The concentrated detergent composition according to claim 14, wherein said organic solvent is propylene glycol, glycerin, or combinations thereof.

16. The concentrated detergent composition according to claim 1, wherein said composition further comprises a dye.

17. The concentrated detergent composition according to claim 1, wherein said composition has a pH of from about −0.7 to about 0.4.

18. (canceled)

19. The concentrated detergent composition according to claim 1, wherein said composition is non-chlorinated.

20. A detergent use solution comprising from about 0.05% to about 5% v/v of the concentrated detergent composition of claim 1 diluted with water.

21. The detergent use solution according to claim 20, wherein said detergent use solution has a pH of from about 1.1 to about 3.2.

22. The detergent use solution according to claim 20, wherein said use solution exhibits an initial foam volume of less than about 600 mL following a dynamic foam test in which 300 mL of said use solution, comprising 0.5% (v/v) of said concentrated detergent diluted with water, is placed inside a 1 liter graduated and subjected to a flow of gas through the diffuser at a flow rate of 2.0 liters per minute for 15 seconds.

23. The detergent use solution according to claim 22, wherein the time to total foam collapse, from stoppage of the gas flow, is less than 5 minutes.

24. A method of removing food soils from a surface of clean-in-place equipment comprising contacting said surface of said clean-in-place equipment with a liquid detergent comprising:
an acidic component comprising an alkanesulfonic acid and optionally an additional acid that is different than said alkanesulfonic acid;
a first surfactant comprising a non-ionic surfactant selected from the group consisting of C6-C20 alcohol ethoxylates; and
a second surfactant comprising a C6-C20 alcohol ethoxylate that is different than said first surfactant,
the weight ratio of said first surfactant to said second surfactant in said composition being from about 2.2:1 to about 22:1,
the weight ratio of said acidic component to the sum of said first and second surfactants being from about 2:1 to about 40:1,
wherein said detergent does not comprise a fatty alkyl-1,3-diaminopropane component.

25. The method according to claim 24, wherein said liquid detergent comprises a use solution prepared by diluting a concentrated detergent composition with water.

26. The method according to claim 25, wherein said use solution comprises from about 0.05% to about 5% v/v of said concentrated detergent composition diluted with water.

27. The method according to claim 25, wherein said use solution has a pH of from about 1.1 to about 3.2.

28. The method according to claim 25, wherein said use solution exhibits an initial foam volume of less than about 600 mL following a dynamic foam test in which 300 mL of said use solution, comprising 0.5% (v/v) of said concentrated detergent diluted with water, is placed inside a 1 liter graduated and subjected to a flow of gas through the diffuser at a flow rate of 2.0 liters per minute for 15 seconds.

29. The method according to claim 28, wherein the time to total foam collapse, from stoppage of the gas flow, is less than 5 minutes.

30. The method according to claim 24, wherein said clean-in-place equipment comprises dairy equipment containing milk soils.

31. The method according to claim 24, wherein said liquid detergent is circulated within said clean-in-place equipment, coming into contact with said soiled surface, for a period of time from about 2 to about 20 minutes.

32. The method according to claim 24, wherein said liquid detergent is circulated within said clean-in-place equipment at a temperature of from about 25° C. to about 85° C.
